(19) United States
(12) Patent Application Publication
(10) Pub. No.: US 2022/0398474 A1
(43) Pub. Date: Dec. 15, 2022

(54) System and Method for Contextual Density Ratio-based Biasing of Sequence-to-Sequence Processing Systems

(71) Applicant: Nuance Communications, Inc., Burlington, MA (US)

(72) Inventors: Jesus Andres Ferrer, Betera (Valencia) (ES); Paul Joseph Vozila, Arlington, MA (US); Dario Albesano, Venaria Reale (Torino) (IT)

(21) Appl. No.: 17/539,271

(22) Filed: Dec. 1, 2021

Related U.S. Application Data
(60) Provisional application No. 63/197,155, filed on Jun. 4, 2021.

(51) Int. Cl. G06N 7/00

(52) U.S. Cl. CPC G06N 7/005

(57) ABSTRACT

A method, computer program product, and computer system for processing one or more portions of an input sequence to generate one or more candidate output sequences, thus defining a plurality of prediction scores for the candidate output sequences. One or more specialized entities may be identified from the candidate output sequences. A first scoring methodology may be applied on the candidate output sequences based upon the portions of the input sequence, thus defining a first set of prediction scores for the one or more candidate output sequences. A second scoring methodology may be applied on the specialized entities from the candidate output sequences based upon the portions of the input sequence, thus defining a second set of prediction scores for the specialized entities. The plurality of predictions scores for the specialized entities may be at least partially modified based upon the first set and the second set of prediction scores.

### RELATED APPLICATION(S)

This application claims the benefit of U.S. Provisional Application No. 63/197,155, filed on 4 Jun. 2021, the entire contents of which are incorporated herein by reference.

### BACKGROUND

Sequence-to-sequence processing systems (e.g., automated scribing systems, automated speech recognition (ASR) systems and other speech or text processing systems) may generally allow for one or more input sequences to be processed or transformed into another sequence or set of sequences (e.g., speech-to-text, text-to-speech, etc.). These sequence-to-sequence processing systems may utilize end-2-end (E2E) models because of their performance and advantages. In the context of language modelling, the E2E models may include or define a language model for various output tokens or sequence segments, either explicitly or implicitly. This may make exploitation of independently trained language models less straightforward than in conventional systems. Accordingly, it may be difficult to dynamically adapt these E2E sequence-to-sequence processing systems for particular contextual profiles for better processing of specific entities (e.g., names entities, special terms, etc.).

### BRIEF SUMMARY OF DISCLOSURE

In one example implementation, a method, performed by one or more computing devices, may include but is not limited to processing one or more portions of an input sequence to generate one or more candidate output sequences, thus defining a plurality of prediction scores for the candidate output sequences. One or more specialized entities may be identified from the candidate output sequences. A first scoring methodology may be applied on the candidate output sequences based upon the portions of the input sequence, thus defining a first set of prediction scores for the one or more candidate output sequences. A second scoring methodology may be applied on the specialized entities from the candidate output sequences based upon the portions of the input sequence, thus defining a second set of prediction scores for the specialized entities. The plurality of predictions scores for the specialized entities may be at least partially modified based upon the first set and the second set of prediction scores.

One or more of the following example features may be included. The one or more machine learning models may include a sequence-to-sequence model configured to process the one or more portions of an input sequence to generate one or more output sequences. One or more output sequences may be generated based upon, at least in part, the plurality of prediction scores for the one or more candidate output sequences. The first scoring methodology may be based upon, at least in part, a first probability distribution associated with an internal language model of the one or more machine learning models. The second scoring methodology may be based upon, at least in part, a second probability distribution associated with an external language model. At least partially modifying the plurality of predictions scores for the one or more specialized entities based upon, at least in part, the first set of prediction scores and the second set of prediction scores may include one or more of: at least partially removing the first set of prediction scores for the one or more specialized entities from the plurality of prediction scores for the one or more candidate output sequences; and adding the second set of prediction scores for the specialized entities to the plurality of predictions scores for the one or more candidate output sequences. Identifying the one or more specialized entities from the one or more candidate output sequences may include tagging a plurality of specialized entities, thus defining one or more tagged portions.

In another example implementation, a computing system may include at least one processor and at least one memory, the at least one processor may be configured to process one or more portions of an input sequence to generate one or more candidate output sequences, thus defining a plurality of prediction scores for the candidate output sequences. One or more specialized entities may be identified from the candidate output sequences. A first scoring methodology may be applied on the candidate output sequences based upon the portions of the input sequence, thus defining a first set of prediction scores for the one or more candidate output sequences. A second scoring methodology may be applied on the specialized entities from the candidate output sequences based upon the portions of the input sequence, thus defining a second set of prediction scores for the specialized entities. The plurality of predictions scores for the specialized entities may be at least partially modified based upon the first set and the second set of prediction scores.

One or more of the following example features may be included. The one or more machine learning models may include a sequence-to-sequence model configured to process the one or more portions of an input sequence to generate one or more output sequences. One or more output sequences may be generated based upon, at least in part, the plurality of prediction scores for the one or more candidate output sequences. The first scoring methodology may be based upon, at least in part, a first probability distribution associated with an internal language model of the one or more machine learning models. The second scoring methodology may be based upon, at least in part, a second probability distribution associated with an external language model. At least partially modifying the plurality of predictions scores for the one or more specialized entities based upon, at least in part, the first set of prediction scores and the second set of prediction scores may include one or more of: at least partially removing the first set of prediction scores for the one or more specialized entities from the plurality of prediction scores for the one or more candidate output sequences; and adding the second set of prediction scores for the specialized entities to the plurality of predictions scores for the one or more candidate output sequences. Identifying the one or more specialized entities from the one or more candidate output sequences may include tagging a plurality of specialized entities, thus defining one or more tagged portions.

In another example implementation, a computer program product may reside on a computer readable storage medium having a plurality of instructions stored thereon which, when executed across one or more processors, may cause at least a portion of the one or more processors to perform operations that may include but are not limited to processing one or more portions of an input sequence to generate one or more candidate output sequences, thus defining a plurality of prediction scores for the candidate output sequences. One or more specialized entities may be identified from the candidate output sequences. A first scoring methodology may be applied on the candidate output sequences based upon the portions of the input sequence, thus defining a first set of prediction scores for the one or more candidate output sequences. A second scoring methodology may be applied on the specialized entities from the candidate output sequences based upon the portions of the input sequence, thus defining a second set of prediction scores for the specialized entities. The plurality of predictions scores for the specialized entities may be at least partially modified based upon the first set and the second set of prediction scores.

One or more of the following example features may be included. The one or more machine learning models may include a sequence-to-sequence model configured to process the one or more portions of an input sequence to generate one or more output sequences. One or more output sequences may be generated based upon, at least in part, the plurality of prediction scores for the one or more candidate output sequences. The first scoring methodology may be based upon, at least in part, a first probability distribution associated with an internal language model of the one or more machine learning models. The second scoring methodology may be based upon, at least in part, a second probability distribution associated with an external language model. At least partially modifying the plurality of predictions scores for the one or more specialized entities based upon, at least in part, the first set of prediction scores and the second set of prediction scores may include one or more of: at least partially removing the first set of prediction scores for the one or more specialized entities from the plurality of prediction scores for the one or more candidate output sequences; and adding the second set of prediction scores for the specialized entities to the plurality of predictions scores for the one or more candidate output sequences. Identifying the one or more specialized entities from the one or more candidate output sequences may include tagging a plurality of specialized entities, thus defining one or more tagged portions.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a model biasing process coupled to an example distributed computing network according to one or more example implementations of the disclosure;

FIG. 2 is an example flowchart of a model biasing process according to one or more example implementations of the disclosure;

FIG. 3 is an example diagrammatic view of the model biasing process according to one or more example implementations of the disclosure;

FIG. 4 is an example diagrammatic view of the model biasing process according to one or more example implementations of the disclosure;

FIG. 5 is an example diagrammatic view of the model biasing process according to one or more example implementations of the disclosure; and

FIG. 6 is an example diagrammatic view of the model biasing process according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

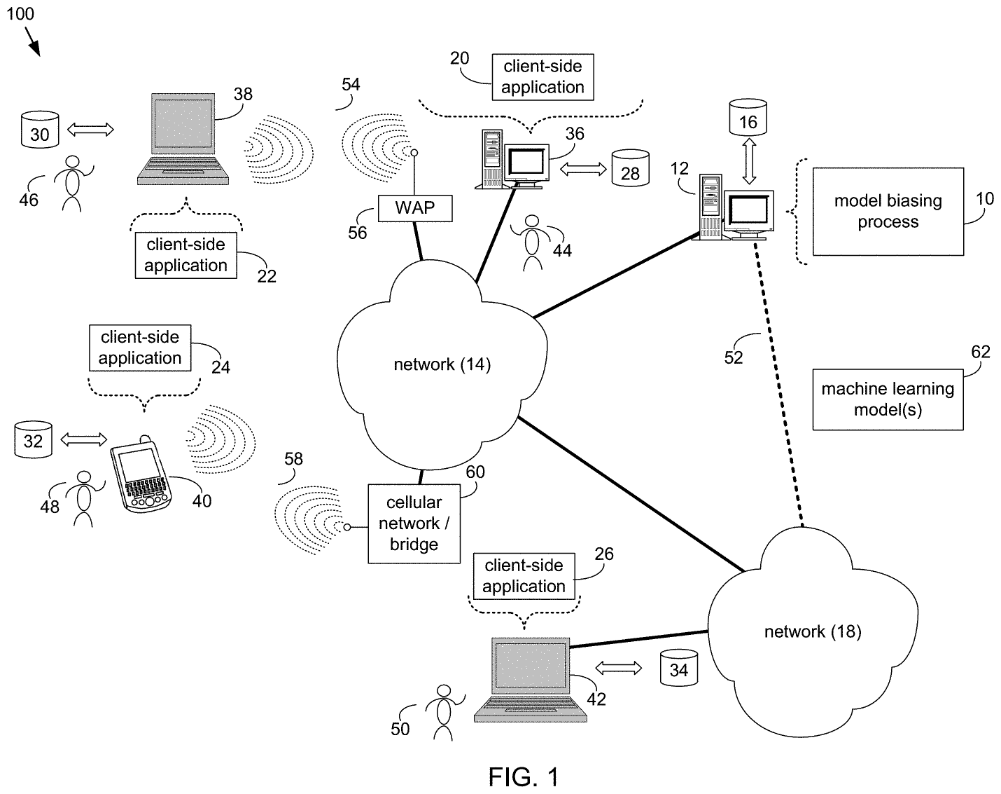

Referring now to the example distributed computing network (e.g., distributed computing network 100) of FIG. 1, there is shown model biasing process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a model biasing process, such as model biasing process 10 of FIG. 1, may process, using one or more machine learning models, one or more portions of an input sequence to generate one or more candidate output sequences, thus defining a plurality of prediction scores for the one or more candidate output sequences. One or more specialized entities may be identified from the one or more candidate output sequences. A first scoring methodology may be applied, using the one or more machine learning models, on the one or more candidate output sequences based upon, at least in part, the one or more portions of the input sequence, thus defining a first set of prediction scores for the one or more candidate output sequences. A second scoring methodology may be applied on the one or more specialized entities from the one or more candidate output sequences based upon, at least in part, the one or more portions of the input sequence, thus defining a second set of prediction scores for the one or more specialized entities. The plurality of predictions scores for the one or more specialized entities may be at least partially modified based upon, at least in part, the first set of prediction scores and the second set of prediction scores.

In some implementations, the instruction sets and subroutines of model biasing process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, model biasing process 10 may be a component of the data store, a standalone application that interfaces with the above noted data store and/or an applet/application that is accessed via client applications 20, 22, 24, 26. In some implementations, the above noted data store may be, in whole or in part, distributed in a cloud computing topology. In this way, computer 12 and storage device 16 may refer to multiple devices, which may also be distributed throughout the network.

In some implementations, model biasing process 10 may be accessed via one or more of client applications 20, 22, 24, 26. In some implementations, model biasing process 10 may be a standalone application, or may be an applet/application/script/extension that may interact with and/or be executed within one or more of client applications 20, 22, 24, 26. Examples of client applications 20, 22, 24, 26 may include, but are not limited to, e.g., a speech processing application (e.g., Dragon® speech recognition software by Nuance Communications, Inc.), a standard and/or mobile web browser, an email application (e.g., an email client application), a textual and/or a graphical user interface, a customized web browser, a plugin, an Application Programming Interface (API), or a custom application. The instruction sets and subroutines of client applications 20, 22, 24, 26, which may be stored on storage devices 28, 30, 32, 34, coupled to client electronic devices 36, 38, 40, 42, may be executed by one or more processors and one or more memory architectures incorporated into client electronic devices 36, 38, 40, 42, may include but are not limited to: hard disk drives; flash drives, tape drives; optical drives; RAID arrays; random access memories (RAM); and read-only memories (ROM). Examples of client electronic devices 36, 38, 40, 42 (and/or computer 12) may include, but are not limited to, a personal computer (e.g., client electronic device 36), a laptop computer (e.g., client electronic device 38), a smart/data-enabled, cellular phone (e.g., client electronic device 40), a notebook computer (e.g., client electronic device 42), a tablet, a server, a television, a smart television, a media (e.g., video, photo, etc.) capturing device, and a dedicated network device. Client electronic devices 36, 38, 40, 42 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 20, 22, 24, 26 may be configured to effectuate some or all of the functionality of model biasing process 10 (and vice versa). Accordingly, in some implementations, model biasing process 10 may be a purely server-side application, a purely client-side application, or a hybrid server-side/client-side application that is cooperatively executed by one or more of client applications 20, 22, 24, 26 and/or model biasing process 10.

In some implementations, one or more of users 44, 46, 48, 50 may access computer 12 and model biasing process 10 (e.g., using one or more of client electronic devices 36, 38, 40, 42) directly through network 14 or through secondary network 18. Further, computer 12 may be connected to network 14 through secondary network 18, as illustrated with phantom link line 54. Model biasing process 10 may include one or more user interfaces, such as browsers and textual or graphical user interfaces, through which users 44, 46, 48, 50 may access model biasing process 10.

In some implementations, the various client electronic devices may be directly or indirectly coupled to network 14 (or network 18). For example, client electronic device 36 is shown directly coupled to network 14 via a hardwired network connection. Further, client electronic device 42 is shown directly coupled to network 18 via a hardwired network connection. Client electronic device 38 is shown wirelessly coupled to network 14 via wireless communication channel 54 established between client electronic device 38 and wireless access point (i.e., WAP) 56, which is shown directly coupled to network 14. WAP 56 may be, for example, an IEEE 802.11a, 802.11b, 802.11g, 802.11n, 802.11ac, RFID, and/or Bluetooth™ (including Bluetooth™ Low Energy) device that is capable of establishing wireless communication channel 54 between client electronic device 38 and WAP 56. Client electronic device 40 is shown wirelessly coupled to network 14 via wireless communication channel 58 established between client electronic device 40 and cellular network/bridge 60, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 20, 22, 24, 26 to, e.g., computer 12. Examples of I/O request 15 may include but are not limited to, data write requests (e.g., a request that content be written to computer 12) and data read requests (e.g., a request that content be read from computer 12).

As discussed above, sequence-to-sequence processing systems (e.g., automated scribing systems, automated speech recognition (ASR) systems, and other speech or text processing systems) may generally allow for one or more input sequences to be processed or transformed into another sequence or set of sequences (e.g., speech-to-text, text-to-speech, etc.). These sequence-to-sequence processing systems may utilize end-2-end (E2E) models because of their performance and advantages. E2E models may be utilize language modelling when processing an input sequence into an output sequence. Language modelling may generally include a technique to determine the probability of an output symbol (e.g., a word) that accounts for the output symbols (e.g., words) that preceded the respective output symbol in the sequence (e.g., a sentence). Language modelling can be based on a statistical approach as well as on neural networks.

In the context of language modelling, the E2E models may include or define a language model (e.g., an “internal” language model) for various output tokens or sequence segments, either implicitly or explicitly. This may make exploitation of independently trained language models less straightforward than in conventional systems. Accordingly, it may be difficult to dynamically adapt these E2E sequence-to-sequence processing systems for particular contextual profiles for better processing of specific entities (e.g., names entities, special terms, etc.). As will be discussed in greater detail below, model biasing process 10 may at least help, e.g., improve the implementation of context-aware models for specific entities. In this manner, implementations of the present disclosure may allow for significant improvements in overall recognition accuracy when processing specific entities within a given input sequence. It will be appreciated that the computer processes described throughout are not considered to be well-understood, routine, and conventional functions.

### The Model Biasing Process:

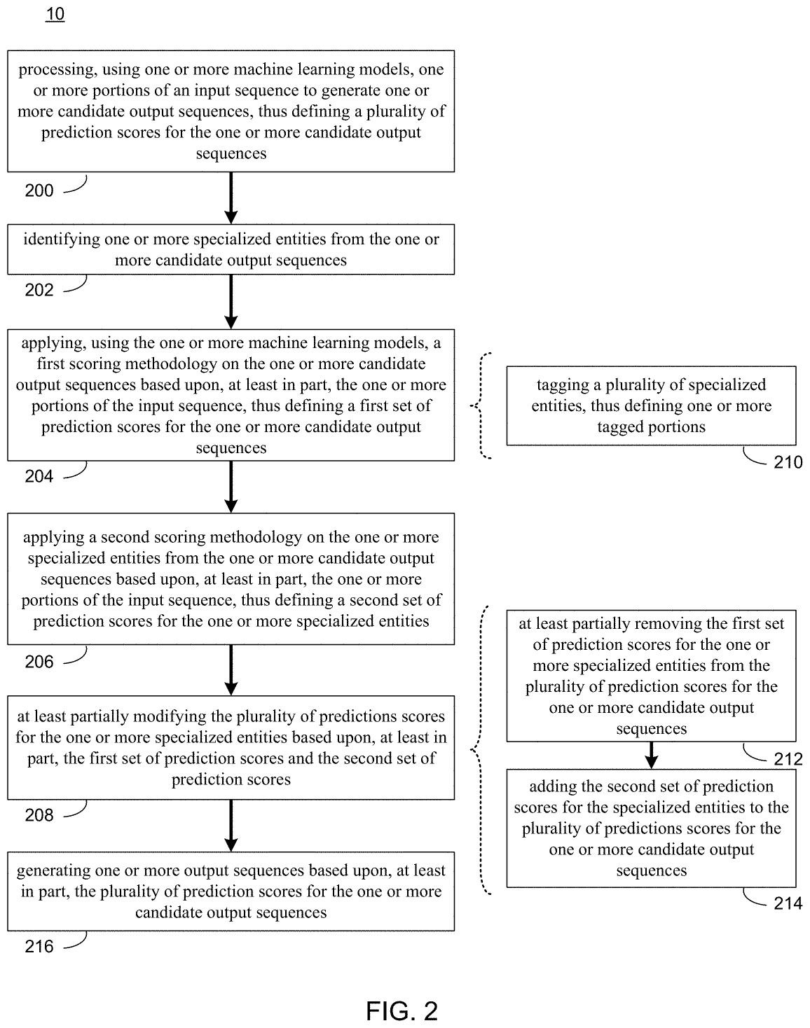

As discussed above and referring also at least to the example implementations of FIGS. 2-6, model biasing process 10 may process 200, using one or more machine learning models, one or more portions of an input sequence to generate one or more candidate output sequences, thus defining a plurality of prediction scores for the one or more candidate output sequences. One or more specialized entities may be identified 202 from the one or more candidate output sequences. A first scoring methodology may be applied 204, using the one or more machine learning models, on the one or more candidate output sequences based upon, at least in part, the one or more portions of the input sequence, thus defining a first set of prediction scores for the one or more candidate output sequences. A second scoring methodology may be applied 206 on the one or more specialized entities from the one or more candidate output sequences based upon, at least in part, the one or more portions of the input sequence, thus defining a second set of prediction scores for the one or more specialized entities. The plurality of predictions scores for the one or more specialized entities may be at least partially modified 208 based upon, at least in part, the first set of prediction scores and the second set of prediction scores.

In some implementations consistent with the present disclosure, systems and methods may be provided for the implementation of contextual density ratio-based biasing of language models for specific entities. For example, implementations of the present disclosure may allow for significant improvements in overall recognition accuracy of specific entities within a given input sequence. As discussed above, end-2-end (E2E) models have become increasingly popular in various sequence-to-sequence system tasks (e.g., ASR) because of their performance advantages. In the context of ASR systems, these E2E models may directly approximate the posterior distribution of output tokens given the acoustic inputs. Consequently, the E2E systems may implicitly or explicitly define a language model (LM) over the output tokens (e.g., an internal language model), which may result in a less straightforward exploitation of independently trained language models than in conventional ASR systems. This may lead to difficulties when attempting to dynamically adapt E2E ASR system to contextual profiles for better recognizing special words such as named entities. In some implementations of the present disclosure, a contextual density ratio approach may be utilized for both training a contextual aware E2E model and adapting the language model to particular entities.

End-to-end (E2E) systems have been adopted for various speech processing systems, such as ASR, because of their performance and simplicity. In conventional ASR systems, several components, such as the pronunciation lexicon, the language models, and the acoustic model, are optimized independently. In contrast, E2E systems integrate all components of conventional ASR systems in a single neural network by directly approximating the posterior probability given the acoustic features.

Despite the direct posterior approximation simplifying many aspects such as training, decoding and deployment found when using E2E systems/models, these advantages do not come without drawbacks. Specifically, one of the disadvantages is the difficulty of exploiting external language models. Since the E2E models directly approximate the posterior token distribution, there is no straightforward way to integrate external language models, which generates recognition problems for more rare entries. For example, the probability of particular entries being observed in an E2E model may be very different from the probability of those entries being observed in a different model. As such, these distinctions cannot be expected to be comprehensively observed in training.

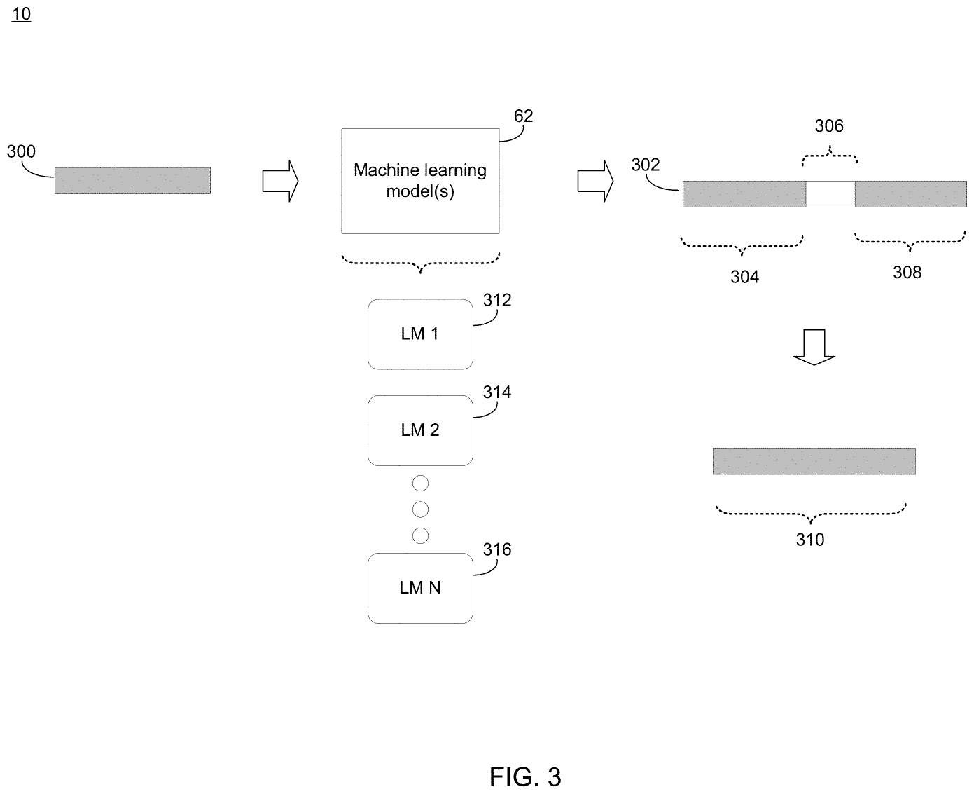

Model biasing process 10 may process 200, using one or more machine learning models, one or more portions of an input sequence to generate one or more candidate output sequences, thus defining a plurality of prediction scores for the one or more candidate output sequences. Referring also to FIG. 3, one or more machine learning models (e.g., machine learning model 62) may directly approximate the probability of a target token sequence given acoustic features. Machine learning model 62 may include neural network sequence-to-sequence/E2E models configured to process 200 a plurality of portions of an input sequence (e.g., input sequence 300). Input sequence 300 may represent any input sequence (e.g., speech, text, or other content) received by model biasing process 10 for processing 200 into one or more candidate output sequences (e.g., candidate output sequence 302 with portions 304, 306, 308). For example, input sequence 300 may represent speech content and machine learning model 62 may be configured to generate one or more candidate output sequences (e.g., candidate output sequence 302) and from the one or more candidate output sequences, generate an output text (e.g., output sequence 310). However, it will be appreciated that input sequence 300 and output sequence 310 may represent any combination of input and output sequences. While candidate output sequence 302 is shown with e.g., three portions (e.g., portions 304, 306, 308), it will be appreciated that the one or more candidate output sequences may include any number of portions within the scope of the present disclosure. The portions of the candidate output sequence may include various segments of text, speech, or other content within an input sequence. In one example, portions 304, 306, 308 may represent various candidate segments or phrases generated for a particular input sequence of speech. For example, portions 304, 306, 308 may represent particular candidate text-based representations of words or phrases spoken recorded by an audio recording system or otherwise received by model biasing process 10.

Processing 200 the one or more portions of an input sequence to generate one or more candidate output sequences may include converting the input signal into a sequence of feature vectors. For example, suppose that input sequence 300 is a speech signal and that machine learning model 62 (e.g., a sequence-to-sequence model) is configured to convert speech to text. In this example, machine learning model 62 may convert speech signals (e.g., input sequence 300) into a sequence of feature vectors. As is known in the art, the process of converting the input sequence into a plurality of feature vectors is called “encoding”. In some implementations, model biasing process 10 may include a plurality of machine learning models (e.g., machine learning model 62) that process encoded features and generate one or more candidate output sequences (e.g., candidate output sequence 302) which may be processed in any quantity by the same machine learning models 62 and a plurality of prediction scores for the one or more candidate output sequences. The plurality of predicting scores may correspond to the probability of a particular token or sequence of tokens representing at least a portion of the candidate output sequence. In some implementations, some of the plurality of machine learning models (e.g., machine learning model 62) may be used by the biasing process 10, to process output symbols generated by the remaining machine learning models.

Model biasing process 10 may identify 202, using the one or more machine learning models, one or more specialized entities from the one or more candidate output sequences. For example, model biasing process 10 may adapt the language model of E2E systems to be able to recognize particular specialized entities (e.g., given names of a contact list; street names of an address list; medical supply brands and products from a medical professional's notes; text macros from a medical professional's notes; etc.). While examples of certain specialized entities have been described above, it will be appreciated that any specified entity type may be identified 202 within the scope of the present disclosure. The specialized entities may occur at any position within the one or more candidate output sequences and may only span a few words. Accordingly, conventional E2E systems and/or the predefined language model of an E2E system may be unable to provide a sufficient hypothesis score for the specialized entities to be included in the output sequence.

Identifying 202 the specialized entity within the one or more candidate output sequences may include tagging 210 a plurality of specialized entities, thus defining one or more tagged portions. For example, model biasing process 10 may tag 210 both beginning and end of entities for a generic entity (e.g., using tags such as “<ne>” and “</ne>”) or specific entities/specific types of entities (e.g., “<place>” and “</place>”; “<name>” and “</name>”; etc.). Model biasing process 10 may receive training data which includes tagged regions for one or more specialized entities. This information may come from an outside source. This tagging may be provided by any entity recognizer applied to the training output sequences; this entity recognizer may be list or regular expression-based or might come from the underlying workflow that created the content (e.g., in a medical scribing application, the “special terms” of interest may be physician-specific text macros and the authoring application may capture when/where scribes insert such a macro into a clinical note). Once the E2E model is trained with these specialized entity tags in its target output data, then it naturally predicts these tagged entities in its output, without any further dependence on the list/model/process that was leveraged to incorporate them into training. For instance, once trained, model biasing process 10 may tag 210 the one or more candidate output sequences (e.g., candidate output sequence 302) with particular tags or other identifiers for specialized entities.

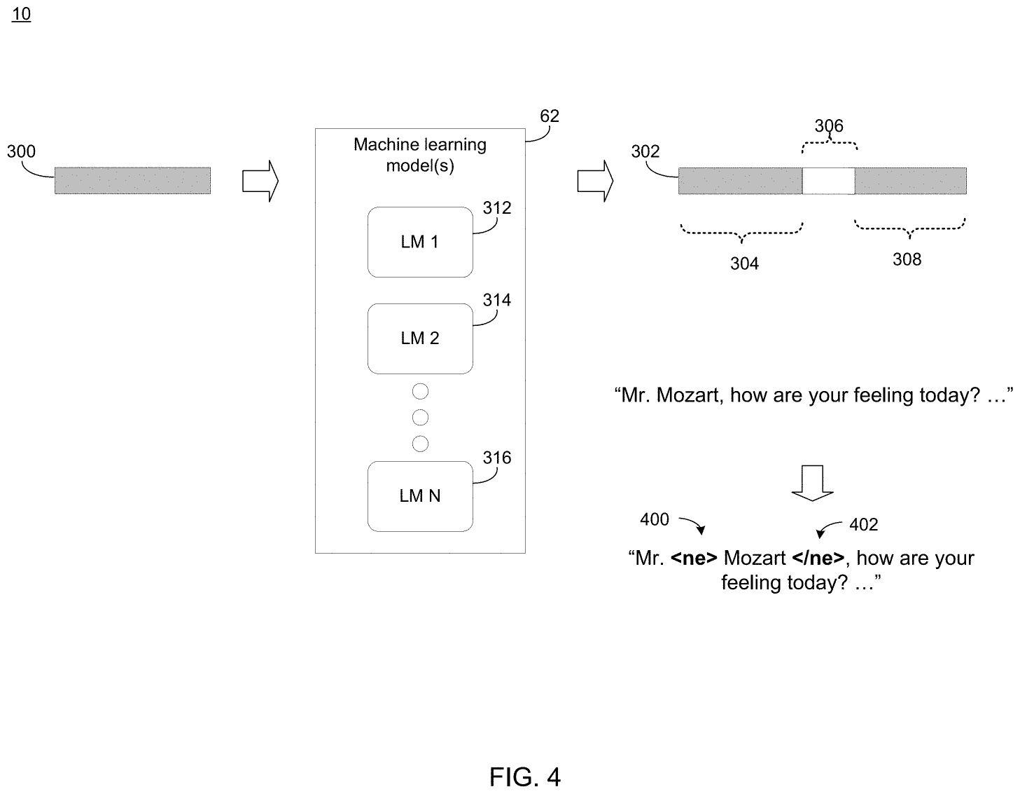

Referring also to FIG. 4, suppose that input sequence 300 is an utterance (e.g., “Mr. Mozart, how are you feeling today?”) and that model biasing process 10 generates candidate output sequence 302 based on input sequence 300. In this example, suppose that LM 312 is populated with names from a contact list. Accordingly, model biasing process 10 may, via machine learning model 62, identify 202 named entity “Mozart” and tag 208 the named entity by adding one or more tags (e.g., tags 400, 402) to the one or more candidate output sequences (e.g., candidate output sequence 302). While the example of FIG. 4 includes a particular specialized entity and the tagging of the specialized entity with tags within candidate output sequence 302, it will be appreciated that any specialized entity may be identified and tagged within the present disclosure and that the above-described tagging is not limited to inserting tags before and/or after the specialized entity.

Continuing with the above example, model biasing process 10 may identify a specialized entity (e.g., portion 306) corresponding to the spoken name “Mozart”. In this example, model biasing process 10 may apply a first scoring methodology corresponding to the entirety of candidate output sequence 302. As will be discussed in greater detail below and in response to identifying 202 a specialized entity (e.g., portion 306 corresponding to the name “Mozart”) within the candidate output sequence (e.g., candidate output sequence 302), model biasing process 10 may apply a second scoring methodology corresponding to the specialized entities identified within the one or more candidate output sequences (e.g., portion 306 of candidate output sequence 302).

Model biasing process 10 may apply 204, using one or more machine learning models, a first scoring methodology on the one or more candidate output sequences based upon, at least in part, the one or more portions of the input sequence, thus defining a first set of prediction scores for the one or more candidate output sequences. For example, the one or more machine learning models (e.g., machine learning model 62) may include various language models (e.g., language models (LMs) 312, 314, 316). While FIG. 3 shows machine learning model 62 including e.g., three language models, it will be appreciated that model biasing process 10 may utilize any number of language models within the scope of the present disclosure. A language model may generally include a listing of output symbols (e.g., words) and their probability of occurrence in a given sequence. For example, typical speech recognition systems use n-gram language models where an n-gram contains the prior probability of the occurrence of an output symbol (unigram), or of a sequence of output symbols (bigram, trigram, etc.). As will be discussed in greater detail below, a scoring methodology may define a particular process for scoring candidate tokens of an output sequence given particular portions of an input sequence.

As discussed above, the end-to-end (E2E) model is a system that directly maps input audio sequence to sequence of words or other graphemes. Most E2E speech recognition models include the following parts: the encoder maps speech input sequence to feature sequence; the aligner realizes the alignment between feature sequence and language; the decoder decodes the final identification result. Note that this division does not always exist since end-to-end itself is a complete structure. Contrary to other models (e.g., the HMM-based model) that consists of multiple modules, the E2E model replaces multiple modules with a deep network, realizing the direct mapping of acoustic signals into label sequences without carefully-designed intermediate states. As the E2E system generally does not have a specific language model, the mapping of particular input sequences to output sequences by the E2E system may be represented as a predefined/internal language model (e.g., LM 312). Accordingly, the predefined language model (e.g., LM 312) for the E2E system may be implicit because of the mapping of input sequences to output sequences or may express (e.g., a defined language model for the E2E system). As discussed above and with conventional implementations of an E2E system, the predefined language model of the E2E system (e.g., LM 312) may not allow for, or account for, external language models (e.g., LM 314, 316). As will be discussed in greater detail below, model biasing process 10 may selectively/contextually bias the scoring of tokens of the output sequence based upon, at least in part, the identification of specialized entities within the input sequence.

In some implementations, the first scoring methodology is based upon, at least in part, a first probability distribution associated with an internal language model of the one or more machine learning models. As discussed above and in some implementations, model biasing process 10 may include an E2E system or model (e.g., machine learning model 62) configured to process 200 one or more input sequences (e.g., input sequence 300) into an output sequence (e.g., output sequence 310) by generating one or more candidate output sequences (e.g., candidate output sequence 302). Machine learning model 62 may utilize a first probability distribution associated with a plurality of tokens of a candidate output sequence as defined by an internal language model of the E2E language model (e.g., LM 312) to process 200 the input sequence (e.g., input sequence 300). For example, machine learning model 62 may be an E2E model/system with an internal language model (e.g., LM 312) configured to map portions of input sequence (e.g., input sequence 300). LM 312 may represent a model trained to approximate the E2E system output distribution of symbols. Accordingly, LM 312 may be an internal language model representative of the E2E system. LM 312 may include a first probability distribution associated with a plurality of tokens of the one or more candidate output sequences. The first probability distribution associated with the plurality of tokens of the one or more candidate output sequences may be defined based upon, at least in part, training data used in the training of the machine learning model. For example, the first probability distribution associated with the plurality of tokens of the output sequence may represented as shown below in Equation 1:

p(y|x)≈pₑ₂ₑ(y|x) (1)

where y is the probability of a particular token within a candidate output sequence given a particular acoustic feature, x, of the input sequence.

Accordingly, the first scoring methodology may include a scoring process for candidate tokens of an output sequence based upon, at least in part, the first probability distribution. As will be discussed in greater detail below, as the first probability distribution may not account for specialized entities in specific contexts (e.g., given names of a contact list; street names of an address list; medical supply brands and products from a medical professional's notes; etc.). Accordingly, model biasing process 10 may identify specialized entities within the one or more candidate output sequences to apply a second scoring methodology to the specialized entities.

Model biasing process 10 may apply 206 a second scoring methodology on the one or more specialized entities from the one or more candidate output sequences based upon, at least in part, the one or more portions of the input sequence, thus defining a second set of prediction scores for the one or more specialized entities. As discussed above, the scoring methodology may concern the probability of a particular token of an output sequence given a particular portion of an input sequence. In response to identifying 202 a specialized entity within the one or more candidate output sequences, model biasing process 10 may apply 206 a second scoring methodology on the specialized entity to define a second set of prediction scores. The second scoring methodology may correspond to a language model specific to the specialized entity. For example and continuing with the above example, suppose LM 312 concerns given names and includes the name “Mozart”. In this example, model biasing process 10 may apply 206 a second scoring methodology on the specialized entity (e.g., portion 306) of the one or more candidate output sequences (e.g., candidate output sequence 302) corresponding to “Mozart”.

In some implementations, the second scoring methodology is based upon, at least in part, a second probability distribution associated with an external language model. As discussed above relative to the first scoring methodology, the first scoring methodology may include a scoring process for candidate tokens of a candidate output sequence based upon, at least in part, the first probability distribution associated with an internal language model of the one or more machine learning models and the plurality of portions of the input sequence. However, the first probability distribution may not account for particular specialized entities in specific contexts (e.g., given names of a contact list; street names of an address list; medical supply brands and products from a medical professional's notes; text macros used by a particular medical professional; etc.). Accordingly, model biasing process 10 may identify 202 specialized entities within the one or more candidate output sequences to apply a second scoring methodology to the specialized entities. In this manner, the second probability distribution associated with the plurality of tokens of the one or more candidate output sequences may be defined by a second language model (e.g., LM 314) corresponding to the specialized entity (e.g., portion 306) identified within the one or more candidate output sequences (e.g., candidate output sequence 302). The second probability distribution associated with the plurality of tokens of the candidate output sequence may be defined by a second language model is represented as shown below in Equation 2 for the specific example where there is a single specialized entity. However, it will be appreciated that this does not limit the scope of the present disclosure to the case of a single entity occurrence per utterance or segment as the same approach may be applied for a plurality of entity occurrences:

$${q}_{p e} ( y \vert x ) = ( {\prod }_{t < {t}_{b}} {p}_{e 2 e} ( {y}_{t} \vert x , {y}_{< t} ) ) \cdot {p}_{e 2 e} ( < n e > \vert x , {y}_{< {t}_{b}} ) {{\prod }^{{t}_{e}}}_{t = {t}_{b} + 1} {p}_{e 2 e} ( {y}_{t} \vert {y}_{< t} , x ) \frac{{q}_{P E} ( {y}_{t} \vert {y}_{{t}_{b}}^{t - 1} )}{{p}_{ID} ( {y}_{t} \vert {y}_{< t} )} \frac{p ( x )}{q ( x )} {\prod }_{t > {t}_{e}} {p}_{e 2 e} ( {y}_{t} \vert x , {y}_{< t} ) \qquad ( 2 )$$

where qₚₑ represents token posterior probability of an utterance with a specialized entity; t_{b} represents the position where a specialized entity begins within an input sequence; tₑ represents the position where a specialized entity ends within an input sequence; <ne> represents an opening tag of a specialized entity tag; yₜ represents a token sequence at position t; and p_{ID} represents the probability distribution of an internal language model.

As shown above in Equation 2, the second probability distribution defines a contextual density ratio between the language model for the particular specialized entities and the language model of the E2E system. For example, Equation 2 provides a contextual density ratio of the probability distribution of a specialized entity within a candidate output sequence based upon a specialized entity-specific language model compared to the probability distribution of a token based upon the in-domain language model. Accordingly, the internal (ID) and external/specialized entity (SE) language models may condition on different context.

In contrast to applying 204 the first scoring methodology (which is based upon a first probability distribution associated with an internal language model of the one or more machine learning models), applying 206 the second scoring methodology may be based upon the context of the specialized entity or entities. Accordingly, model biasing process 10 may introduce contextual density ratio-based biasing for named entities by applying 206 a second scoring methodology specific to the specialized entity as opposed to the first scoring methodology defined by the E2E system. In this manner, model biasing process 10 may perform more accurate sequence-to-sequence processing by applying probability distributions for tokens of a candidate output sequence using language models specific to particular specialized entities.

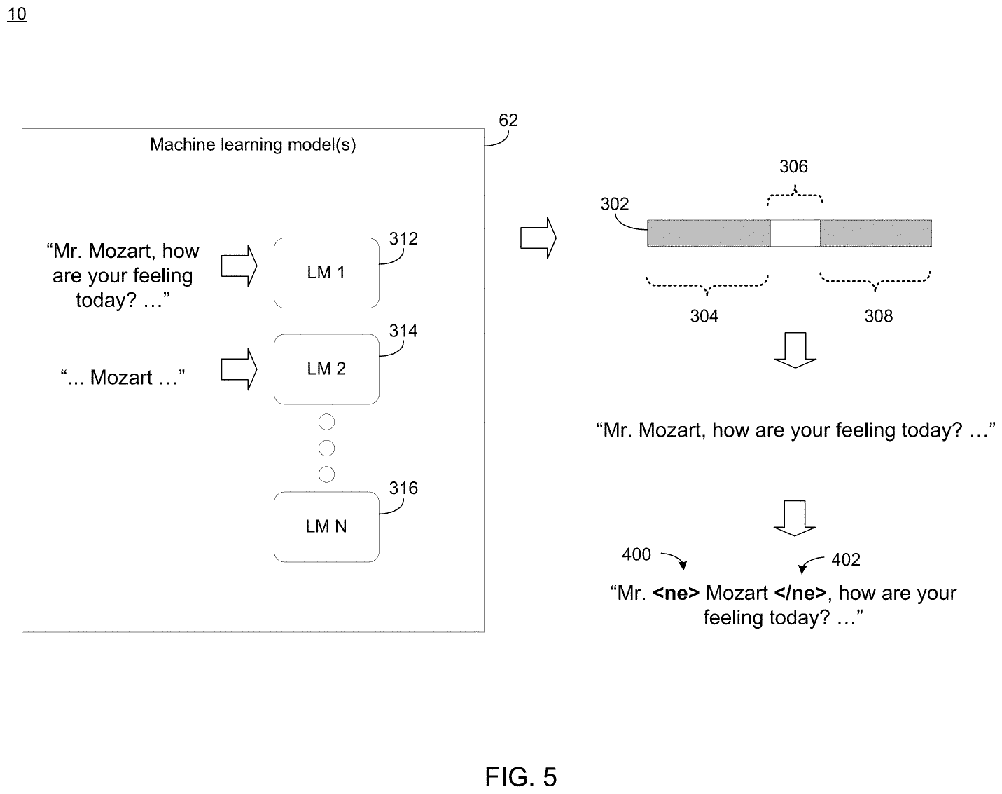

Referring also to FIG. 5, model biasing process 10 may apply 202 a first scoring methodology on the entirety of the candidate output sequence (e.g., candidate output sequence 302) and may apply 206 a second scoring methodology on the specialized entities identified within the candidate output sequence (e.g., portion 306). Continuing with the above example, model biasing process 10 may apply 202 the first scoring methodology defined by LM 312 to the context of the entirety of candidate output sequence 302 (e.g., “Mr. Mozart, how are you feeling today?”) and may apply 206 the second scoring methodology defined by LM 312 to the context of the specialized entity (e.g., “Mozart” defined by tags “<ne>” and “</ne>”). The first scoring methodology and/or the second scoring methodology may be applied at several points during decoding. For example, the first scoring methodology and/or the second scoring methodology may be applied synchronously per output time step to the plurality of symbols on the one or more candidate output sequences. In another example, the first scoring methodology and/or the second scoring methodology may be applied in cascade during post-processing; or in stages on the full sequence.

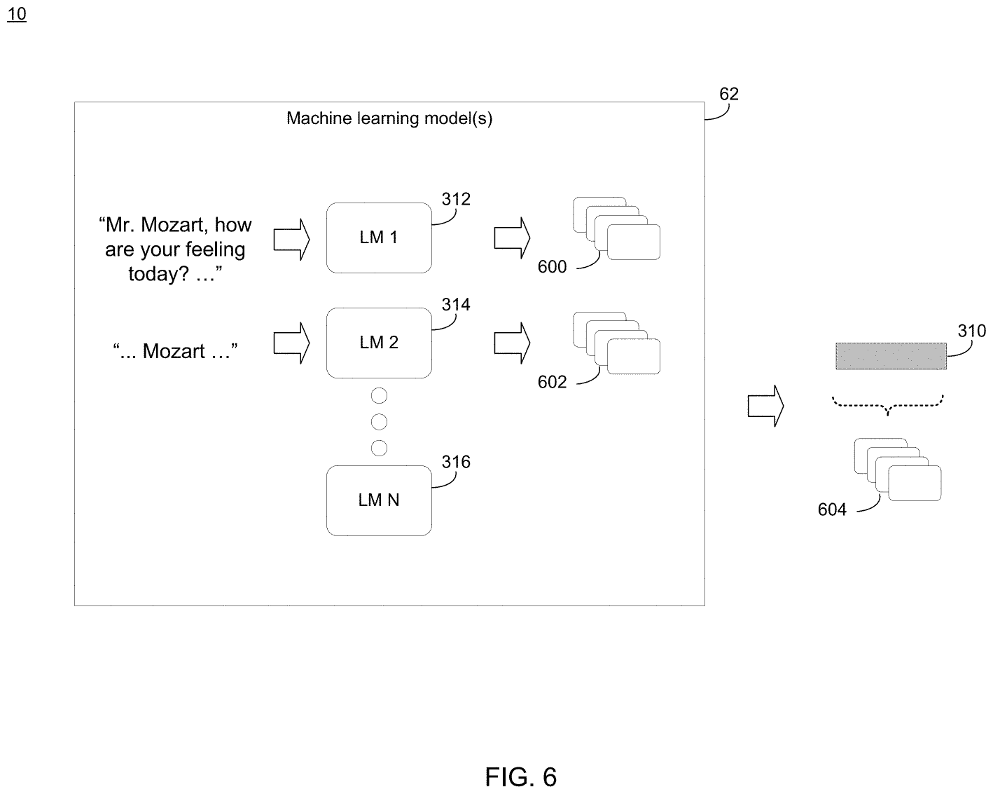

Model biasing process 10 may at least partially modify 208 the plurality of predictions scores for the one or more specialized entities based upon, at least in part, the first set of prediction scores and the second set of prediction scores. Referring also to FIG. 6 and in some implementations, model biasing process 10 may define a first set of prediction scores using the first scoring methodology defined by LM 312 and a second set of prediction scores using the second scoring methodology define by LM 314.

For example and continuing with the above example, suppose model biasing process 10 defines a first set of prediction scores (e.g., first set of prediction scores 600) associated with a first scoring methodology defined by the E2E language model (e.g., LM 312). As discussed above, LM 312 may represent a model trained to represent the E2E system. Accordingly, LM 312 may be an internal language model representative of the E2E system. Further suppose that model biasing process 10 defines a second set of prediction scores (e.g., second set of prediction scores 602) associated with a second scoring methodology defined by the E2E language model (e.g., LM 314). In this example, model biasing process 10 may at least partially modify 208 the plurality of prediction scores based upon, at least in part, the first set of prediction scores (e.g., first set of prediction scores 600) for the one or more specialized entities and the second set of prediction scores (e.g., second set of prediction scores 602). During beam search or decoding (i.e., the generation of the output sequence), each token of the candidate output sequence may be scored as shown below in Equation 3:

$$score ( {y}_{t} ) = \{ \begin{matrix}log {p}_{e 2 e} ( {y}_{t} \vert … ) + log \frac{{{q}_{P E} ( {y}_{t} \vert {y}_{{t}_{b}}^{t - 1} )}^{β}}{{{p}_{ID} ( {y}_{t} \vert {y}_{< t} )}^{α}} , se ( {y}_{< t} ) \\ log {p}_{e 2 e} ( {y}_{t} \vert … ) , o . w .\end{matrix} \qquad ( 3 )$$

where log pₑ₂ₑ corresponds to the probability distribution for the plurality of tokens as defined by the E2E system (i.e., the first scoring methodology); and a and correspond to tunable scalars for weighting the probability distribution for the plurality of tokens as defined by an internal language model and the probability distribution for the plurality of tokens as defined by the language model specific to the specialized entities, respectively.

As shown above in Equation 3, se(y_{<t}) indicates whether there is an open specialized entity tag in the previous tokens that has not yet been closed and in such a case, t_{b}:=t_{b}(y_{<t}) is the position of the beginning tag token, <ne>. Language model distributions may be weighted by a and to smoothen them. Equation 3 may be simplified as shown below in Equation 4, when biasing i.e. when within specialized entity tags:

score=log pₑ₂ₑ−α log(ID)+β log(SE) (4)

where log pₑ₂ₑ corresponds to the probability distribution for the plurality of tokens as defined by the E2E system (i.e., the first scoring methodology); log(ID) corresponds to the probability distribution for the plurality of tokens as defined by an internal language model; log(SE) corresponds to the probability distribution for the plurality of tokens as defined by the external language model specific to the specialized entities (i.e., the second scoring methodology); α and β correspond to tunable scalars for weighting the probability distribution for the plurality of tokens as defined by an internal language model and the probability distribution for the plurality of tokens as defined by the language model specific to the specialized entities, respectively. The tunable scalars may be user-defined, defined automatically by model biasing process 10, and/or may be determined experimentally. In one example, the tuneable scalars may be a function of the context similarly to other probability distributions. Accordingly, it will be appreciated that the tuneable scalars may be defined in various ways within the scope of the present disclosure. Additionally, it will be appreciated that various biasing components may be utilized by a plurality of machine learning models that are approximating different distributions for different domains. For example, while the above example describes the procedure for a simple type of named entities and a single biasing specialized entity score, log(SE), model biasing process 10 may process several tags and/or types of specialized entities with unique distributions for each specialized entity (e.g., unique log(SE)). In one example, the full sequence of output symbols (e.g. a sentence or a paragraph) may be generalized as follows:

score=log pₑ₂ₑ−α log(ID)+Σᵢ₌₁^{Num SE}βᵢ log(SEᵢ) (5)

where log pₑ₂ₑ is the E2E score of the full sequence of output symbols, log(ID) is the internal language model compensation applied only to the one or more entities, and each log(SEᵢ) defines a potentially unique probability distribution for the plurality of tokens applied for each of the identified specialized entities as defined by an external language model specific to each specialized entity type together with its corresponding scalar weights, βᵢ.

Referring again to FIG. 6, model biasing process 10 may at least partially modify 208 the plurality of prediction scores (e.g., the set of prediction scores generated by the E2E system) to define a set of prediction scores for the specialized entities (e.g., set of prediction scores 604). For example, model biasing process 10 may partially modify 208 the first set of prediction scores by weighting the first set of prediction scores (e.g., first set of prediction scores 600) and subtracting/removing/biasing the weighted first set of prediction scores from the plurality of prediction scores. In another example, model biasing process 10 may at least partially remove 212 the first set of prediction scores by erasing them from the plurality of prediction scores. In another example, model biasing process 10 may add 214 the second set of prediction scores for the specialized entities to the plurality of predictions scores for the one or more candidate output sequences. As shown above in Equation 4, model biasing process 10 may at least partially remove the first set of prediction scores for the one or more specialized entities representative of the contribution of the internal language model of the E2E system (e.g., log(ID)) and add the second set of prediction scores for the one or more specialized entities associated with the external language model (e.g., log(SE)). While two examples have been provided for at least partially modifying 208 the plurality of prediction scores, it will be appreciated that these are for example purposes only and that model biasing process 10 may remove/subtract/bias the first set of prediction scores from the plurality of prediction scores in various ways within the scope of the present disclosure.

Accordingly, model biasing process 10 may utilize the first set of prediction scores (e.g., first set of prediction scores 600) for the one or more candidate output sequences generally and may utilize the second set of prediction scores (e.g., second set of prediction scores 602) for the specialized entities identified within the one or more candidate output sequences (e.g., the one or more candidate output sequences corresponding to “Mozart”). In this manner, model biasing process 10 may provide a contextual biasing of the language models used by the sequence-to-sequence model/processing system to allow more accurate sequence processing of particular specialized entities.

As shown above in Equation 3, the E2E model may score each token independently of whether it is within a named entity tag, in contrast to both internal (ID) LM (e.g., LM 312) and the specialized entity (SE) LM (e.g., LM 314). Since the ID LM (e.g., LM 312) is removed/subtracted/biased to counteract the internal E2E LM, it is tracking the same context as the E2E model, which in some systems matches with the full utterance, whereas the SE LM (e.g., LM 314), may only track the context within the contextual specialized entity phrase.

Model biasing process 10 may generate 216 the output sequence based upon, at least in part, the plurality of prediction scores associated with the one or more candidate output sequences. Referring again to FIG. 6, model biasing process 10 may generate 216 an output sequence (e.g., output sequence 310) using the plurality of prediction scores defined for the one or more candidate output sequences (e.g., candidate output sequence 302 as shown in FIGS. 3-5). In this manner, model biasing process 10 may allow for contextual biasing of language models of an E2E system that accounts for particular specialized entities.

In some implementations of the present disclosure, it has been observed that contextual density ratio biasing as described above reduces name errors by 46.5% relative with respect to the E2E baseline. Accordingly, it will be appreciated that implementations of the present disclosure may allow for increased accuracy in sequence-to-sequence processing systems (e.g., automated scribing applications, ASR systems, and other speech processing systems) by providing contextual biasing that accounts for particular specialized entities and the probabilities associated with the specialized entities.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, executed on a computing device, comprising:
processing, using one or more machine learning models, one or more portions of an input sequence to generate one or more candidate output sequences, thus defining a plurality of prediction scores for the one or more candidate output sequences;
identifying one or more specialized entities from the one or more candidate output sequences;
applying, using the one or more machine learning models, a first scoring methodology on the one or more candidate output sequences based upon, at least in part, the one or more portions of the input sequence, thus defining a first set of prediction scores for the one or more candidate output sequences;
applying a second scoring methodology on the one or more specialized entities from the one or more candidate output sequences based upon, at least in part, the one or more portions of the input sequence, thus defining a second set of prediction scores for the one or more specialized entities; and
at least partially modifying the plurality of predictions scores for the one or more specialized entities based upon, at least in part, the first set of prediction scores and the second set of prediction scores.

2. The computer-implemented method of claim 1, wherein the one or more machine learning models include a sequence-to-sequence model configured to process the one or more portions of an input sequence to generate one or more output sequences.

3. The computer-implemented method of claim 1, further comprising:
generating one or more output sequences based upon, at least in part, the plurality of prediction scores for the one or more candidate output sequences.

4. The computer-implemented method of claim 1, wherein the first scoring methodology is based upon, at least in part, a first probability distribution associated with an internal language model of the one or more machine learning models.

5. The computer-implemented method of claim 4, wherein the second scoring methodology is based upon, at least in part, a second probability distribution associated with an external language model.

6. The computer-implemented method of claim 5, wherein at least partially modifying the plurality of predictions scores for the one or more specialized entities based upon, at least in part, the first set of prediction scores and the second set of prediction scores includes one or more of:
at least partially removing the first set of prediction scores for the one or more specialized entities from the plurality of prediction scores for the one or more candidate output sequences; and
adding the second set of prediction scores for the specialized entities to the plurality of predictions scores for the one or more candidate output sequences.

7. The computer-implemented method of claim 1, wherein identifying the one or more specialized entities from the one or more candidate output sequences includes:
tagging a plurality of specialized entities, thus defining one or more tagged portions.

8. A computer program product residing on a non-transitory computer readable medium having a plurality of instructions stored thereon which, when executed by a processor, cause the processor to perform operations comprising:
processing, using one or more machine learning models, one or more portions of an input sequence to generate one or more candidate output sequences, thus defining a plurality of prediction scores for the one or more candidate output sequences;
identifying one or more specialized entities from the one or more candidate output sequences;
applying, using the one or more machine learning models, a first scoring methodology on the one or more candidate output sequences based upon, at least in part, the one or more portions of the input sequence, thus defining a first set of prediction scores for the one or more candidate output sequences;
applying a second scoring methodology on the one or more specialized entities from the one or more candidate output sequences based upon, at least in part, the one or more portions of the input sequence, thus defining a second set of prediction scores for the one or more specialized entities; and
at least partially modifying the plurality of predictions scores for the one or more specialized entities based upon, at least in part, the first set of prediction scores and the second set of prediction scores.

9. The computer program product of claim 8, wherein the one or more machine learning models include a sequence-to-sequence model configured to process the one or more portions of an input sequence to generate one or more output sequences.

10. The computer program product of claim 8, wherein the operations further comprise:
generating one or more output sequences based upon, at least in part, the plurality of prediction scores for the one or more candidate output sequences.

11. The computer program product of claim 8, wherein the first scoring methodology is based upon, at least in part, a first probability distribution associated with an internal language model of the one or more machine learning models.

12. The computer program product of claim 11, wherein the second scoring methodology is based upon, at least in part, a second probability distribution associated with an external language model.

13. The computer program product of claim 12, wherein at least partially modifying the plurality of predictions scores for the one or more specialized entities based upon, at least in part, the first set of prediction scores and the second set of prediction scores includes one or more of:
at least partially removing the first set of prediction scores for the one or more specialized entities from the plurality of prediction scores for the one or more candidate output sequences; and
adding the second set of prediction scores for the specialized entities to the plurality of predictions scores for the one or more candidate output sequences.

14. The computer program product of claim 8, wherein identifying the one or more specialized entities from the one or more candidate output sequences includes:
tagging a plurality of specialized entities, thus defining one or more tagged portions.

15. A computing system comprising:
a memory; and
a processor configured to process, using one or more machine learning models, one or more portions of an input sequence to generate one or more candidate output sequences, thus defining a plurality of prediction scores for the one or more candidate output sequences, wherein the processor is further configured to identify one or more specialized entities from the one or more candidate output sequences, wherein the processor is further configured to apply, using the one or more machine learning models, a first scoring methodology on the one or more candidate output sequences based upon, at least in part, the one or more portions of the input sequence, thus defining a first set of prediction scores for the one or more candidate output sequences, wherein the processor is further configured to apply a second scoring methodology on the one or more specialized entities from the one or more candidate output sequences based upon, at least in part, the one or more portions of the input sequence, thus defining a second set of prediction scores for the one or more specialized entities, and wherein the processor is further configured to at least partially modify the plurality of predictions scores for the one or more specialized entities based upon, at least in part, the first set of prediction scores and the second set of prediction scores.

16. The computing system of claim 15, wherein the one or more machine learning models include a sequence-to-sequence model configured to process the one or more portions of an input sequence to generate one or more output sequences.

17. The computing system of claim 15, wherein the processor is further configured to:
generate one or more output sequences based upon, at least in part, the plurality of prediction scores for the one or more candidate output sequences.

18. The computing system of claim 15, wherein the first scoring methodology is based upon, at least in part, a first probability distribution associated with an internal language model of the one or more machine learning models.

19. The computing system of claim 18, wherein the second scoring methodology is based upon, at least in part, a second probability distribution associated with an external language model.

20. The computing system of claim 19, wherein at least partially modifying the plurality of predictions scores for the one or more specialized entities based upon, at least in part, the first set of prediction scores and the second set of prediction scores includes one or more of:
at least partially removing the first set of prediction scores for the one or more specialized entities from the plurality of prediction scores for the one or more candidate output sequences; and
adding the second set of prediction scores for the specialized entities to the plurality of predictions scores for the one or more candidate output sequences.
